(19) United States
(12) Patent Application Publication
(10) Pub. No.: US 2017/0031575 A1
(43) Pub. Date: Feb. 2, 2017

(54) TAILORED COMPUTING EXPERIENCE BASED ON CONTEXTUAL SIGNALS

(71) Applicant: MICROSOFT TECHNOLOGY LICENSING, LLC, REDMOND, WA (US)

(72) Inventors: DIKLA DOTAN-COHEN, Herzliya (IL); IDO PRINESS, Herzliya (IL); HAIM SOMECH, Ramat Gan (IL); ASSAF AVIHOO, Redmond, WA (US)

(21) Appl. No.: 14/811,626

(22) Filed: Jul. 28, 2015

(51) Int. Cl. G06F 3/0484

(52) U.S. Cl. CPC G06F 3/04847; G06F 3/04842

(57) ABSTRACT

Systems, methods, and computer-readable storage media are provided for tailoring or customizing computing experiences based upon contextual signals. One or more contextual signals associated with a user of a computing device are detected. Based upon the detected contextual signal(s), a probable action of the user is predicted, for instance, taking into account historical actions of the user and/or cumulative historical actions of a plurality of users as such actions relate to the detected contextual signal(s). At least one user interface, such as an action menu is automatically (that is, without affirmative user interaction) customized to include a menu item that can activate a function to help complete the probable action.

### BACKGROUND

Computing devices have limited screen space to communicate available commands and functions to a user. Today's computing devices can perform a large number of different tasks. Even within an individual program or application the number of different tasks an application may perform can be enormous. It is a challenge for applications and devices to present all relevant options to the user given the limited screen space available to display options. There is a need to make better use of limited computer resources to present options the user wants in a given context.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various aspects, systems, methods, and computer-readable storage media are provided to make efficient use of limited computing resources, such as screen space, by dynamically altering user interfaces to include commands a user is likely to want in a given context. One or more contextual signals associated with a user of a computing device (e.g., personal, habitual, and/or environmental cues) are extracted from user interactions with a computing device. Based upon the detected contextual signal(s), a probable action of the user is predicted, for instance, taking into account historical actions of the user and/or cumulative historical actions of a plurality of users as such actions relate to the detected contextual signal(s). In one aspect, the contextual information can include the content of user communications and other presently active objects.

In one aspect, menu items within an application are automatically altered to include one or more actions the user is likely to take based on the content of recent user interactions with a device, not just interactions within the application. For example, email content from an email application could be used to generate a customized menu item in a picture sharing application. Automatic modification of application interfaces when signals are detected make the computing system more efficient by reducing the number of interfaces that need to be generated. Displaying an available action on a top level interface where it is selected by a user avoids the need to generate multiple lower level interfaces where the available action can normally be found by default. Such probable action prediction followed by automatic application and/or program UI modification additionally may save the user time and effort, as well as may serve as a reminder for the user of a particular action he or she would typically take when a given set of circumstances (e.g., signals) is detected.

### BRIEF DESCRIPTION OF THE DRAWINGS

The technology described herein is illustrated by way of example and not limitation in the accompanying figures in which like reference numerals indicate similar elements and in which:

FIG. 1 is a block diagram of an example operating environment suitable for implementations of the present disclosure;

FIG. 2 is a diagram depicting an example computing architecture suitable for implementing aspects of the present disclosure;

FIG. 3 is a flow diagram showing an exemplary method for tailoring a user computing experience based upon contextual signals, in accordance with an aspect of the technology described herein;

FIG. 4 is a flow diagram showing another exemplary method for tailoring a user experience based upon contextual signals, in accordance with an aspect of the technology described herein;

FIGS. 5-7 are flow diagrams showing additional exemplary methods of inferring a probable user action, in accordance with an aspect of the technology described herein; and

FIG. 8 is a block diagram of an exemplary computing environment suitable for use in implementing aspects of the technology described herein.

### DETAILED DESCRIPTION

The various technology described herein are set forth with sufficient specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

In various aspects, systems, methods, and computer-readable storage media are provided to make efficient use of limited computing resources, such as screen space, by dynamically altering user interfaces to include commands or menu items a user is likely to use in a given context. One or more contextual signals associated with a user's interactions with a computing device (e.g., personal, habitual, and/or environmental cues) are extracted from the content of user interactions. In one aspect, the contextual information can include the content of user communications and other presently active computing objects.

“Contextual signals,” as utilized herein, may reflect any attribute of a user (for instance, physical characteristics), the user's historical interaction with the system (e.g., behavior, habits, and system interaction patterns), and/or the user's recent interaction with the system (with “recency” being defined in accordance with a predetermined time frame relative to a given point in time) that may affect the likelihood or probability that the user desires to engage with a particular computer application or computer program. Such contextual signals may include, by way of example only and not limitation, the location of the user of the computing device (determined utilizing, for instance, Global Positioning System (GPS) signals, Internet Protocol (IP) address, or the like), the time of day (either general (for instance, morning or afternoon) or exact (for instance, 6:00 pm)), the date (either exact or generally a particular month, season, etc.), a physical characteristic of the user (for instance, if the user is paralyzed and capable of only voice input, or the like), a task currently engaged in on the computing device by the user, a task recently engaged in on the computing device by the user (again with “recency” being defined in accordance with a predetermined time frame relative to a given point in time), an object the user is currently engaged with on the computing device (for instance, an entity such as a contact, a file, an image, or the like), an object the user was recently engaged with on the computing device, a function currently being performed by the user on the computing device, a function recently performed by the user on the computing device, hardware currently being utilized on the computing device, hardware recently utilized on the computing device, software currently being utilized on the computing device, and software recently utilized on the computing device.

In accordance with aspects hereof, one or more contextual signals associated with the user are detected. Such detection may occur utilizing sensors (e.g., GPS sensors to identify location, time/date sensors integrated within the computing system, sensors that are configured to mine data and characteristics from a user profile, and the like). Based upon the detected contextual signal(s), a probable action of the user may be predicted. Such predictions may be made, for instance, taking into account historical actions of the user and/or cumulative historical actions of a plurality of users as such actions relate to the detected contextual signal(s). At least one UI feature, such as a menu item, is automatically generated upon a user opening the menu.

The technology described herein can monitor user interactions with various applications across multiple devices to ascertain patterns between user interactions and subsequent actions. The subsequent actions are described herein as probable actions. The probable action may be performed in conjunction with a computer application. The observed actions and the probable actions may form a series of association rules. For example, analysis of the user interactions may reveal a pattern that a user who downloads digital pictures into a photo album subsequently communicates one or more of the photos to a person depicted in the photos. In this case, the observed interaction would be downloading digital pictures and a probable action would be sharing the digital pictures.

The probable actions may be associated with contextual information that indicates when or in what context the user will perform the probable action. A context associated with the probable action could be opening a communication application, such as an email program, within a threshold amount of time of downloading the digital photos. Aspects of the technology described herein may store this probable action sequence within a semantic action store that stores a plurality of probable action sequences for a particular user.

Further, text or other data associated with the user interaction may be extracted and stored as semantic data for use in generating a customized menu item and to help an application complete the probable action for the user. The person depicted in the photo may form semantic data. The person depicted could be associated with an email address or phone number that can be supplied to help the user send an email or text.

Aspects of the technology described herein can utilize the probable action sequences to generate customized user interface features such as customized menu actions. The customized menu actions can include content extracted from the user interactions. The customized menu actions can replace default menu actions that would typically be shown in a menu. Returning to the email application example, a default menu or user interface may include a “new email” action. The technology described herein could replace the “new email” action with a customized action button stating “new email to Sam,” where Sam is the name of a person appearing in the recently downloaded photos.

Thus, where the predicted user action is that a user will share a photo of her friends with the friends who are the subject of the photo (based in part on a user interaction comprising the user's taking the photo on a user device), upon viewing the photo, the user may be provided access to a menu having a menu item corresponding to initiating an application (such as email, instant message, text, or the like) to share the photo with those specific friends of the photo. The identities of the friends in the photo may be determined using facial recognition or other contextual information associated with the content, and their contact information determined from the user's contact list. Further, in some embodiments, a recipients field for sharing the photo (such as the “To” field in an email) may be automatically populated with address information for the specific friends in the photograph. In this way, after taking a picture of a group of friends (a user interaction), the user may be presented (regardless of which of the user's user devices was used to take the photo) with a menu (or notification, or similar content item) to facilitate carrying out the probable action, namely, sharing the photo with the people in the photo.

Content logic may specify conditions, also described as context, for presenting the customized action. For example, suppose on Wednesday a user receives an email inviting her to a party on Saturday night. On Saturday night, upon determining that the user is in her car, a maps/navigation program (or personal assistant application) on the user's phone includes a menu option for navigating to the party's location. The conditions and relevant time to present a menu with the directions to the party were determined based on the content of the email.

Further, in some embodiments, probable action sequences can be generated using user interactions (which may include historical activity) from other similar users (i.e., crowdsourcing). In particular, user activity history may also be utilized in conjunction with a user's own activity history. For example, for a given user, a set of other users similar to the given user may be identified, based on having features or characteristics in common with the given user. This might include other users located in proximity to the given user, the given user's social media friends, work colleagues (which may be determined from an analysis of contextual information associated with the given user), other users with similar user interactions, or the like. Information about user activity history from the other users may be relied upon for inferring probable actions for the given user. This may be particularly useful in situations where little user activity history exists for the given user, such as where the user is a new user.

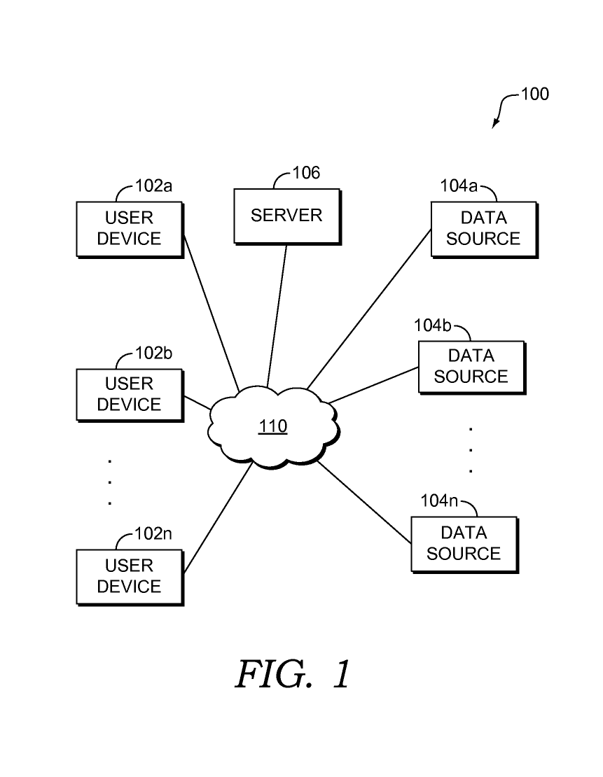

Having briefly described an overview of aspects of the technology described herein, an exemplary operating environment in which aspects of the technology described herein may be implemented is described below in order to provide a general context for various aspects. Referring to the figures in general and initially to FIG. 1 in particular, an exemplary operating environment for implementing technology described herein is shown and designated generally as exemplary operating environment 100. The exemplary operating environment 100 is but one example of a suitable computing environment and is not intended to suggest any limitation as to the scope of use or functionality of aspects of the technology described herein. Neither should the exemplary operating environment 100 be interpreted as having any dependency or requirement relating to any one component nor any combination of components illustrated.

Turning now to FIG. 1, a block diagram is provided showing an example operating environment 100 in which some aspects of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

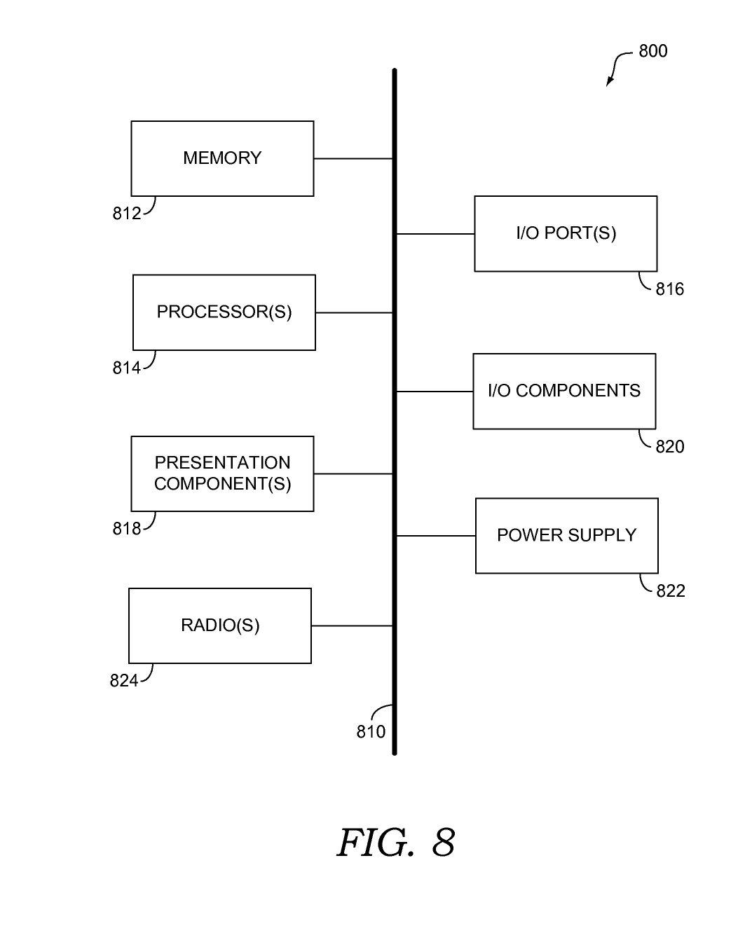

Among other components not shown, example operating environment 100 includes a number of user devices, such as user devices 102a and 102b through 102n; a number of data sources, such as data sources 104a and 104b through 104n; server 106; and network 110. It should be understood that environment 100 shown in FIG. 1 is an example of one suitable operating environment. Each of the components shown in FIG. 1 may be implemented via any type of computing device, such as computing device 800 described in connection to FIG. 8, for example. These components may communicate with each other via network 110, which may include, without limitation, one or more local area networks (LANs) and/or wide area networks (WANs). In exemplary implementations, network 110 comprises the Internet and/or a cellular network, amongst any of a variety of possible public and/or private networks.

User devices 102a and 102b through 102n can be client devices on the client-side of operating environment 100, while server 106 can be on the server-side of operating environment 100. The user devices can facilitate the completion of tasks and make a record of user interactions. The user interactions can be analyzed to identify patterns between initial interactions and subsequent actions. A. Server 106 can comprise server-side software designed to work in conjunction with client-side software on user devices 102a and 102b through 102n so as to implement any combination of the features and functionalities discussed in the present disclosure. For example, the server 106 may run a probable action inference engine 270, that identifies a probable action. The server 106 may receive communication records from the user devices. This division of operating environment 100 is provided to illustrate one example of a suitable environment, and there is no requirement for each implementation that any combination of server 106 and user devices 102a and 102b through 102n remain as separate entities.

User devices 102a and 102b through 102n may comprise any type of computing device capable of use by a user. For example, in one aspect, user devices 102a through 102n may be the type of computing device described in relation to FIG. 8 herein. By way of example and not limitation, a user device may be embodied as a personal computer (PC), a laptop computer, a mobile or mobile device, a smartphone, a tablet computer, a smart watch, a wearable computer, a virtual reality headset, augmented reality glasses, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, or any combination of these delineated devices, or any other suitable device.

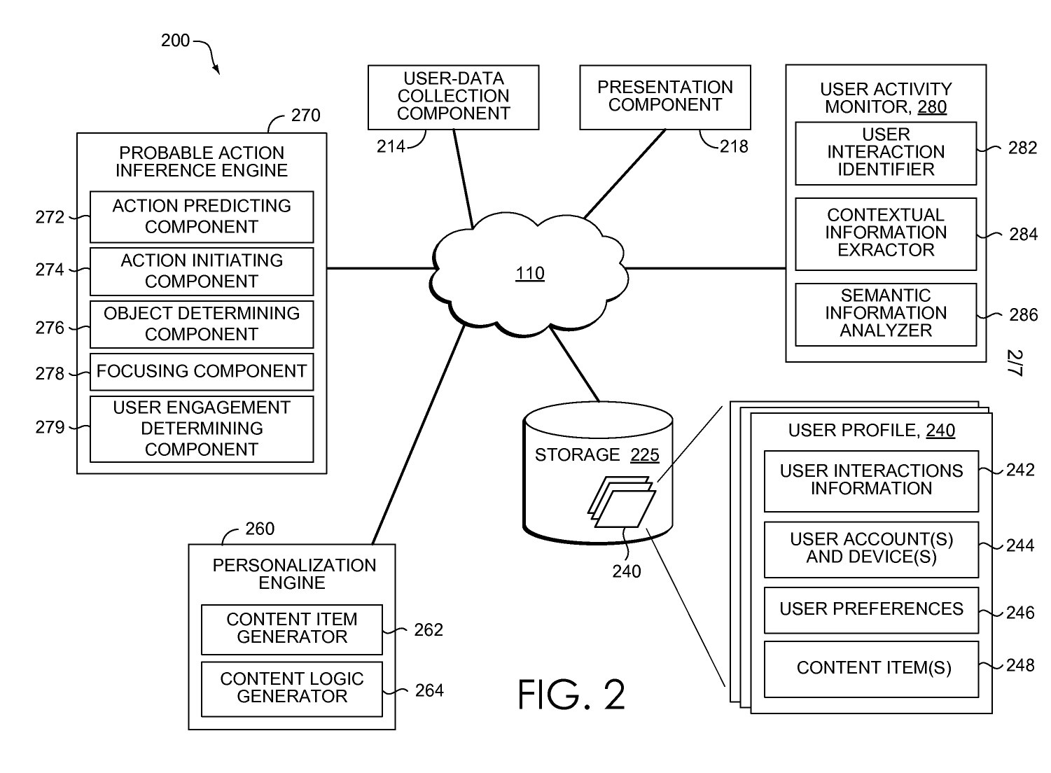

Data sources 104a and 104b through 104n may comprise data sources and/or data systems, which are configured to make data available to any of the various constituents of operating environment 100, or system 200 described in connection to FIG. 2. (For example, in one aspect, one or more data sources 104a through 104n provide (or make available for accessing) user data to user-data collection component 214 of FIG. 2.) Data sources 104a and 104b through 104n may be discrete from user devices 102a and 102b through 102n and server 106 or may be incorporated and/or integrated into at least one of those components. In one aspect, one or more of data sources 104a though 104n comprise one or more sensors, which may be integrated into or associated with one or more of the user device(s) 102a, 102b, or 102n or server 106. Examples of sensed user data made available by data sources 104a though 104n are described further in connection to user-data collection component 214 of FIG. 2. The data sources 104a though 104n can comprise a knowledge base that stores information about a venue, a user, or other entity related to a particular user action.

Operating environment 100 can be utilized to implement one or more of the components of system 200, described in FIG. 2, including components for collecting user data, monitoring user actions, generating probable action sequences, determining probable actions, and/or presenting customized menu options.

Referring now to FIG. 2, with FIG. 1, a block diagram is provided showing aspects of an example computing system architecture suitable for implementing an embodiment and designated generally as system 200. System 200 represents only one example of a suitable computing system architecture. Other arrangements and elements can be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example system 200 includes network 110, which is described in connection to FIG. 1, and which communicatively couples components of system 200 including user-data collection component 214, presentation component 218, user activity monitor 280, probable action inference engine 270, personalization engine 260, and storage 225. User activity monitor 280 (including its components 282, 284, and 286), personalization engine 260 (including its components 262 and 264), user-data collection component 214, presentation component 218, and probable action inference engine 270 (including its components 272, 274, 276, 278, and 279) may be embodied as a set of compiled computer instructions or functions, program modules, computer software services, or an arrangement of processes carried out on one or more computer systems, such as computing device 800 described in connection to FIG. 8, for example.

In one embodiment, the functions performed by components of system 200 are associated with one or more personal assistant applications, services, or routines. In particular, such applications, services, or routines may operate on one or more user devices (such as user device 102a), servers (such as server 106), may be distributed across one or more user devices and servers, or be implemented in the cloud. Moreover, in some embodiments, these components of system 200 may be distributed across a network, including one or more servers (such as server 106) and client devices (such as user device 102a), in the cloud, or may reside on a user device, such as user device 102a. Moreover, these components, functions performed by these components, or services carried out by these components may be implemented at appropriate abstraction layer(s), such as the operating system layer, application layer, hardware layer, etc., of the computing system(s). Alternatively, or in addition, the functionality of these components and/or the embodiments described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 200, it is contemplated that in some embodiments functionality of these components can be shared or distributed across other components.

Continuing with FIG. 2, user-data collection component 214 is generally responsible for accessing or receiving (and in some cases also identifying) user data from one or more data sources, such as data sources 104a and 104b through 104n of FIG. 1. In some embodiments, user-data collection component 214 may be employed to facilitate the accumulation of user data of a particular user (or in some cases, a plurality of users including crowdsourced data) for user activity monitor 280, probable action inference engine 270, or personalization engine 260. The data may be received (or accessed), and optionally accumulated, reformatted, and/or combined, by user-data collection component 214 and stored in one or more data stores such as storage 225, where it may be available to other components of system 200. For example, the user data may be stored in or associated with a user profile 240, as described herein. In some embodiments, any personally identifying data (i.e., user data that specifically identifies particular users) is either not uploaded or otherwise provided from the one or more data sources with user data, is not permanently stored, and/or is not made available to user activity monitor 280 and/or probable action inference engine 270.

User data may be received from a variety of sources where the data may be available in a variety of formats. For example, in some embodiments, user data received via user-data collection component 214 may be determined via one or more sensors, which may be on or associated with one or more user devices (such as user device 102a), servers (such as server 106), and/or other computing devices. As used herein, a sensor may include a function, routine, component, or combination thereof for sensing, detecting, or otherwise obtaining information such as user data from a data source 104a, and may be embodied as hardware, software, or both. By way of example and not limitation, user data may include data that is sensed or determined from one or more sensors (referred to herein as sensor data), such as location information of mobile device(s), properties or characteristics of the user device(s) (such as device state, charging data, date/time, or other information derived from a user device such as a mobile device), user-activity information (for example: app usage; online activity; searches; voice data such as automatic speech recognition; activity logs; communications data including calls, texts, instant messages, and emails; website posts; other user data associated with communication events; etc.) including, in some embodiments, user activity that occurs over more than one user device, user history, session logs, application data, contacts data, calendar and schedule data, notification data, social-network data, news (including popular or trending items on search engines or social networks), online gaming data, e-commerce activity (including data from online accounts such as Microsoft®, Amazon.com®, Google®, eBay®, PayPal®, video-streaming services, gaming services, or Xbox Live®), user-account(s) data (which may include data from user preferences or settings associated with a personal assistant application or service), home-sensor data, appliance data, global positioning system (GPS) data, vehicle signal data, traffic data, weather data (including forecasts), wearable device data, other user device data (which may include device settings, profiles, network-related information (e.g., network name or ID, domain information, workgroup information, connection data, Wi-Fi network data, or configuration data, data regarding the model number, firmware, or equipment, device pairings, such as where a user has a mobile phone paired with a Bluetooth headset, for example, or other network-related information), gyroscope data, accelerometer data, payment or credit card usage data (which may include information from a user's PayPal account), purchase history data (such as information from a user's Xbox Live, Amazon.com, or eBay account), other sensor data that may be sensed or otherwise detected by a sensor (or other detector) component(s) including data derived from a sensor component associated with the user (including location, motion, orientation, position, user-access, user-activity, network-access, user-device-charging, or other data that is capable of being provided by one or more sensor component), data derived based on other data (for example, location data that can be derived from Wi-Fi, Cellular network, or IP address data), and nearly any other source of data that may be sensed or determined as described herein.

In some respects, user data may be provided in user-data streams or signals. A “user signal” can be a feed or stream of user data from a corresponding data source. For example, a user signal could be from a smartphone, a home-sensor device, a GPS device (e.g., for location coordinates), a vehicle-sensor device, a wearable device, a user device, a gyroscope sensor, an accelerometer sensor, a calendar service, an email account, a credit card account, or other data sources. In some embodiments, user-data collection component 214 receives or accesses data continuously, periodically, or as needed.

User activity monitor 280 is generally responsible for monitoring user data for information that may be used for determining user activity information regarding user interactions, which may include identifying and/or tracking features (sometimes referred to herein as “variables”) or other information regarding specific user interactions and related contextual information. Embodiments of user activity monitor 280 may determine, from the monitored user data, user interactions associated with a particular user. The user activity information (regarding the user interactions) determined by user activity monitor 280 may include user interaction information from multiple user devices associated with the user and/or from cloud-based services associated with the user (such as email, calendars, social-media, or similar information sources), and which may include contextual information associated with an identified user interaction. User activity monitor 280 may determine current or near-real-time user interaction information and may also determine historical user interaction information, in some embodiments, which may be determined based on gathering observations of user activity over time and accessing user logs of past activity (such as browsing history, for example). Further, in some embodiments, user activity monitor 280 may determine user interactions (which may include historical activity) from other similar users (i.e., crowdsourcing). In particular, crowdsourced user activity history may also be utilized in conjunction with a user's own activity history. For example, for a given user, a set of other users similar to the given user may be identified, based on having features or characteristics in common with the given user. This might include other users located in proximity to the given user, the given user's social media friends, work colleagues (which may be determined from an analysis of contextual information associated with the given user), other users with similar user interactions, or the like. Information about user activity history from the other users may be relied upon for inferring probable actions for the given user. This may be particularly useful in situations where little user activity history exists for the given user, such as where the user is a new user.

In some embodiments, information determined by user activity monitor 280 may be provided to probable action inference engine 270 including, in some implementations, related contextual information or semantic information. Some embodiments may further provide this information to personalization engine 260. As described previously, user interaction features may be determined by monitoring user data received from user-data collection component 214. In some embodiments, the user data and/or information about the user interactions determined from the user data is stored in a user profile, such as user profile 240.

In an embodiment, user activity monitor 280 comprises one or more applications or services that analyze information detected via one or more user devices and/or cloud-based services associated with the user, to determine user interaction information and related contextual information. Information about user devices associated with a user may be determined from the user data made available via user-data collection component 214, and may be provided to probable action inference engine 270, among other components of system 200.

As shown in example system 200, user activity monitor 280 comprises a user interaction identifier 282, contextual information extractor 284, and semantic information analyzer 286. In some embodiments, user activity monitor 280, one or more of its subcomponents, or other components of system 200, such as probable action inference engine 270, may determine interpretive data from received user data. Interpretive data corresponds to data utilized by these components of system 200 or subcomponents of user activity monitor 280 to interpret user data. For example, interpretive data can be used to provide other context to user data, which can support determinations or inferences made by the components or subcomponents. Moreover, it is contemplated that embodiments of user activity monitor 280, its subcomponents, and other components of system 200 may use user data and/or user data in combination with interpretive data for carrying out the objectives of the subcomponents described herein. Additionally, although several examples of how user activity monitor 280 and its subcomponents may identify user interaction information are described herein, many variations of user interaction identification and user activity monitoring are possible in various embodiments of the disclosure.

User interaction identifier 282, in general, is responsible for determining (or identifying) a user interaction has occurred. Embodiments of user interaction identifier 282 may be used for determining current user interactions or one or more historical user interactions. Some embodiments of user interaction identifier 282 may monitor user data for user-interaction-related features or variables corresponding to user interactions such as indications of communications received or sent, applications used, files accessed, modified, copied, etc., websites navigated to, social media activity, online content downloaded and rendered or played, or similar user interactions.

Additionally, some embodiments of user interaction identifier 282 extract from the user data information about user interactions, which may include current user interaction information, historical user interaction information, and/or related information such as contextual information. (Alternatively or in addition, in some embodiments, contextual information extractor 284 determines and extracts contextual information.) Examples of extracted user interaction information may include app usage, online activity, searches, communications (e.g., calls, including missed calls, emails, instant messages, social media posts, texts, or other communication events), usage duration, application data or content (e.g., content of emails, messages, posts, user status, notifications, etc.), or nearly any other data related to user interactions. Among other components of system 200, the identified user interaction information determined by user interaction identifier 282 may be provided to other subcomponents of user activity monitor 280, probable action inference engine 270, or personalization engine 260. Further, the determined user interaction information may be stored in a user profile associated with the user, such as in user interactions information component 242 of user profile 240. In some embodiments, user interaction identifier 282 or user activity monitor 280 (or its other subcomponents) performs conflation on the detected user interaction information. For example, overlapping information may be merged and duplicated or redundant information eliminated.

In some embodiments, the user-interaction-related features may be interpreted to determine a user interaction has occurred. For example, in some embodiments, user interaction identifier 282 employs user interaction identification logic, which may include rules, conditions, and associations, to identify user interactions. Once a user interaction is determined, these features, or additional related features may be detected and associated with the detected activity for use in inferring probable user actions.

In some embodiments, user interaction identifier 282 runs on or in association with each user device for a user. User interaction identifier 282 may include functionality that polls or analyzes aspects of the user device, such as the operating system or installed applications, to determine user-interaction-related features, network communications, and/or other user interactions detectable via the user device.

Contextual information extractor 284, in general, is responsible for determining contextual information related to the user interaction (identified by user interaction identifier 282 or user activity monitor 280), such as context features or variables associated with user interaction, related information, which may include content associated with the user interaction (e.g., the content of communications (which may include information about the parties of the communication (i.e., sender/caller or recipients)), applications, websites browsed, music listened to, movies played, etc.) and further responsible for associating the determined contextual information with the detected user interaction.

Some embodiments of contextual information extractor 284 determine contextual information related to a user action. By way of example and not limitation, this may include entities identified in a user interaction or related to the interaction (e.g., venues, people, objects, etc., such as recipients of a group email sent by the user or people in a photo taken by the user on the user's mobile device, which may be identified using facial recognition of the user's contacts or social media friends), location or venue of the user's device associated with the user interaction, information about the location venue information (e.g., this is the user's office location, home location, school, restaurant, move theater, etc.), time, day, and/or date; or any other information related to the user interaction that is detectable that may be used for determining patterns of user activity.

In embodiments using contextual information related to user devices, a user device may be identified by detecting and analyzing characteristics of the user device, such as device hardware, software such as operating system (OS), network-related characteristics, user accounts accessed via the device, and similar characteristics. For example, information about a user device may be determined using functionality of many operating systems to provide information about the hardware, OS version, network connection information, installed application, or the like. In some embodiments, a device name or identification (device ID) may be determined for each device associated with a user. This information about the identified user devices associated with a user may be stored in a user profile associated with the user, such as in user account(s) and device(s) 244 of user profile 240. In an embodiment, the user devices may be polled, interrogated, or otherwise analyzed to determine contextual information about the devices. This information may be used for determining a label or identification of the device (e.g., a device ID) so that user interactions on one user device may be recognized and distinguished from user interactions on another user device. In some embodiments, users may declare or register a user device, such as by logging into an account via the device, installing an application on the device, connecting to an online service that interrogates the device, or otherwise providing information about the device to an application or service. In some embodiments, devices that sign into an account associated with the user, such as a Microsoft® account or Net Passport, email account, social network, or the like, are identified and determined to be associated with the user.

In some implementations, contextual information extractor 284 may receive user data from user-data collection component 214, parse the data, in some instances, and identify and extract context features. The context features may be stored as a related set of contextual information associated with the user interaction, and may be stored in a user profile such as in user interactions information 242. In some cases, contextual information personalization engine 260 can personalize a user experience. Contextual information also may be determined from the user data of one or more users, in some embodiments, which may be provided by user-data collection component 214 in lieu of or in addition to user activity information for the particular user.

Semantic information analyzer 286 is generally responsible for determining semantic information associated with the user-interaction-related features (which may include contextual-information features) identified by user activity monitor 280. For example, while a feature regarding the content of a user interaction may indicate a specific audio file listened to by the user or even mentioned in an email received by the user, semantic analysis may determine the category of music, related music, themes or topics, or other entities associated with the audio file for the user interaction. Semantic information analyzer 286 may determine additional user-interaction-related features that are semantically related to the user interaction (including the contextual information regarding the user interaction) that may be used for inferring a probable action by the user.

In particular, a semantic analysis may be performed on the user interaction information, which may include contextual information, to characterize aspects of the user interaction. For example, the user-interaction-related features associated with a specific user interaction may be categorized, such as by type, time frame or location, work-related, home-related, themes, related entities, or the like. In some embodiments, semantic information analyzer 286 uses a semantic knowledge representation, such as a relational knowledge graph. Semantic information analyzer 286 may also be used to characterize user-interaction-related content or other contextual information, such as determining that a location associated with the user interaction corresponds to a hub or venue of interest to the user (such as the user's home, work, gym, or the like) based on frequency of user visits. Semantic analysis may categorize the user interaction as being associated with work or home. In this way, the semantic analysis provided by semantic information analyzer 286 may provide other relevant features of the user interactions for use in inferring a probable user action. Additionally, the semantic information determined from semantic information analyzer 286 may be merged with (or become part of) the contextual information determined by contextual information extractor 284. In this regard, the semantic information may be considered additional contextual information about the user interaction.

Continuing with system 200 of FIG. 2, probable action inference engine 270 is generally responsible for determining probable or likely actions of a user based upon received user-interaction-related information determined from user activity monitor 280. In some embodiments, probable action inference engine 270 may run on a server, as a distributed application across multiple devices, or in the cloud. Probable action inference engine 270 may provide information indicating a determined probable action to personalization engine 260, where it may be consumed to provide a tailored user experience to the user. Additionally, in some implementations, probable action inference engine 270 may be configured to transmit signals for initiation of computer applications and/or programs for facilitating the inferred probable actions.

At a high level, probable action inference engine 270 may receive user-interaction-related information, which may include contextual information, and which may be uploaded from client-side applications or services associated with user activity monitor 280. One or more inference algorithms may be applied to the user-interaction-related information to determine a set of one or more probable user actions. In some embodiments, a corresponding confidence score is also determined for an inferred action. In particular, the confidence score may indicate the strength of the inference, which may reflect the likelihood that the user will perform the action in the future. More specifically, in some embodiments, a corresponding confidence weight or confidence score may be determined regarding an inferred user action. The confidence score may be based on the strength of the inference, which may be determined by the number of observations (e.g., observations of a particular user interaction), the number of features associated with the interaction, how frequently the user's actions are consistent with past inferred actions, the age or freshness of the user interaction observations, or the strength of an association between the user interactions and the inferred future action, for example, where the user almost always shares photos she takes of her friends with those friends, it may be determined that there is a stronger association between the user interaction (e.g., taking a photo of friends) and an inferred future action (e.g., emailing or messaging the photo to the friends who are in the photo). In some instances, the confidence score may be considered when personalizing content. For example, in some embodiments, a minimum confidence score may be needed before using the inferred action to provide an improved user experience or other service by embodiments described herein. In one embodiment, a threshold of 0.6 is utilized such that only inferred actions having a 0.6 (or greater) likelihood of occurring may be considered.

In some implementations, probable action inference engine 270 may determine user patterns, habits, or interests based on contextual information (including content) associated with the user interactions received from user activity monitor 280. Such information may include, without limitation, information regarding a user's desired actions, historical actions of the user as they relate to particular detected user interactions, and cumulative historical actions of a plurality of users as such actions relate to particular detected user actions (e.g., crowdsourced information, such as described previously).

As shown in example system 200, the embodiment of probable action inference engine 270 includes an action predicting component 272, an action initiating component 274, an object determining component 276, a focusing component 278, and an engagement determining component 279. Upon receiving user interaction information from user activity monitor 280, action predicting component 272 may be configured to predict at least one probable or likely action of the user based upon the information received. Such predictions may be made, for instance, taking into account historical actions of the user and/or cumulative historical actions of a plurality of users as such actions relate to the detected user-interaction-related information. In some aspects, the action predicting component 272 may be configured to utilize user interactions information 242 for such historical action information for use in making relevant action predictions.

In some embodiments, the action initiating component 274 may be configured to transmit signals for initiation of computer applications and/or programs for facilitating probable actions predicted by the action predicting component 272, for instance, to a user device associated with the user, personalization engine 260, or other application or service that consumes the predicted user action (not shown). The terms “predicted action” and “probable action” may be used interchangeably within this disclosure and have the same meaning. Action initiating component 274 may be configured to inform the user device or personalization engine 260 that, based on an analysis of the received user-interaction-related information, the user is likely to perform a particular action on the user device. In some embodiments, action initiating component 274 may also instruct the user device to automatically initiate the appropriate computer application, i.e., without affirmative user action to facilitate such initiation. In some embodiments, personalization engine 260 may also receive information about the user interaction(s) that are the basis for the predicted user action, which may include the contextual information. Moreover, in some implementations of where personalization engine 260 receives a predicted user action, functionality provided by certain subcomponents of probable action inference engine 270, such as subcomponents 276, 278, or 279, is not needed, and embodiments of probable action inference engine 270 may omit these or other subcomponents.

Object determining component 276 is configured to determine a target object associated with the first probable action of the user, for instance, an entity such as a contact, a file, an image, or the like, about which the user would likely desire to focus an initiated computer program or application. Focusing component 278 accordingly may be configured to focus an automatically initiated computer program or application around the target object for further facilitating a predicted probable action. In certain aspects, the focusing component 278 may focus the computer program or application by transmitting to a user device or personalization engine 260 signals indicative of the target object about which the initiated program may focus.

At times and in some embodiments, upon detection of a contextual feature in the user-interaction-related information that is instructive of a probable desired action of the user, the user may be otherwise engaged with a user device. In such instances, it may be disruptive to the user if the computing system 200 were to automatically initiate the probable desired computer application or program in an active window or the like associated with the user device. In such instances, it may be less disruptive and improve the user computing experience if a computer application or program for facilitating a desired action was initiated in the background of the computing environment. In other instances, for instance, where the user is not presently engaged with the user device, it may be perfectly acceptable to initiate a computer application or program for facilitating a desired action in the foreground or an active window of the user device. To facilitate such aspects, engagement determining component 279 may be configured to determine whether the user is currently engaged with a particular user device, which may be identified from contextual information, and to, accordingly, instruct that a computer program or application for facilitating a predicted probable action be initiated in the background of the particular user device or the foreground of the particular user device as appropriate.

Continuing with FIG. 2, example computer system 200 includes a personalization engine 260. It is contemplated that some implementations of the disclosure may operate with personalization engine 260 to facilitate providing a personalized user experience, such as described previously. Thus, personalization engine 260 may be considered one example of an application or service (or set of applications or services) that may consume information regarding user action predictions.

At a high level, personalization engine 260 is responsible for generating and providing aspects of personalized user experiences, such as personalized content or tailored delivery of content to a user. The content may be provided to the user as a personalized menu (or item within a menu) in regards to an application associated with the predicted user action; a notification, which may comprise a recommendation, request, or suggestion, (including, for example a notification item in a menu of notifications); or notification, such as described in connection to presentation component 218. The personalized content may be provided to a user device associated with the user, an application or service of the user, or may be provided as part of an API where it may be consumed by another application or service. As described previously, content may be provided at a time when the user would most likely desire to receive it, such as just prior to the user performing the predicted user action.

As shown in example computer system 200, personalization engine 260 includes a content item generator 262 and a content logic generator 264. Content item generator 262, in general, is responsible for generating content for presentation to the user, based on the predicted user action. In one embodiment, the generated content may include a user-interface menu item for an application or service related to the predicted user action. In some embodiments, content item generator 262 determines content that corresponds to the predicted user action, such as a recommendation, suggestion, or menu item for performing an activity or service that is in some way related to the probable action, such as launching an application, navigating to a website, or receiving information.

For example, where the predicted user action is that a user will share a photo of her friends with the friends who are the subject of the photo (based in part on a user interaction comprising the user's taking the photo on a user device), upon viewing the photo, the user may be provided access to a menu having a menu item corresponding to initiating an application (such as email, instant message, text, or the like) to share the photo with those specific friends in the photo. The identities of the friends in the photo may be determined using facial recognition or other contextual information associated with the content, and their contact information determined from the user's contact list. Further, in some embodiments, a recipients field for sharing the photo (such as the “To” field in an email) may be automatically populated with address information for the specific friends in the photograph. In this way, after taking a picture of a group of friends (a user interaction), the user may be presented (regardless of which of the user's user devices was used to take the photo) with a menu (or notification, or similar content item) to facilitate carrying out the probable action, namely, sharing the photo with the people in the photo.

Content items generated by content item generator 262 may be provided to a presentation component 218 for presentation to a user on a user device. In some embodiments, the generated content items may be stored in a user profile associated with the user, such as in content items component 248 of user profile 240. In some cases, the content may include content logic specifying conditions for presenting the content (or otherwise providing the information to the user). Accordingly, content logic generator 264 is generally responsible for generating this logic. In various implementations, the content logic may be generated based on user data, such as time(s), location(s), mode(s), or other parameters relating to presenting content (such as a menu or other notification). For example, the content item may include logic specifying that the content should be presented within a certain time frame of a time corresponding to the predicted user action. Similarly, content logic may specify conditions for presenting the content, such as when location information in the user data indicates the user is at work, or driving in his car. For example, suppose on Wednesday a user receives an email inviting her to a party on Saturday night. On Saturday night, upon determining that the user is in her car, a maps/navigation program (or personal assistant application) on the user's phone includes a menu option for navigating to the party's location. The conditions and relevant time to present a menu with the directions to the party were determined based on the content of the email.

Content logic may further specify how (i.e., which format) to present the content, for example, where it is determined that a user is driving, content may be provided in an audio format (for example, by a computer-based voice). The content logic generated by content logic generator 264 may be stored with content items, such as in content items component 248 of user profile 240. In some embodiments, content logic may be determined based on user preferences or settings (such as provided by user preferences 246), which may be explicitly provided by a user or inferred from usage-related and time-related features, which may include user patterns, or settings provided by other users.

Example system 200 also includes a presentation component 218 that is generally responsible for presenting content and related information to a user, based on the personalized content from personalization engine 260. Presentation component 218 may comprise one or more applications or services on a user device, across multiple user devices, or in the cloud. For example, in one embodiment, presentation component 218 manages the presentation of personalized content to a user across multiple user devices associated with that user. Based on content logic, user-interaction-related information, current user data, and/or predicted user action(s), presentation component 218 may determine on which user device(s) a content is presented (or provided), as well as the context of the presentation, such as how (or in what format and how much content, which can be dependent on the user device or context) it is provided, when it is provided, etc. In particular, in some embodiments, presentation component 218 applies content logic to the user-interaction-related information, current user data, and/or predicted user action(s) to determine aspects of content presentation.

In some embodiments, presentation component 218 generates user interface features associated with the personalized content. Such features can include interface elements (such as graphics buttons, sliders, menus, audio prompts, alerts, alarms, vibrations, pop-up windows, notification-bar or status-bar items, in-app notifications, or other similar features for interfacing with a user), queries, and prompts.

Example system 200 also includes storage 225. Storage 225 generally stores information including data, computer instructions (e.g., software program instructions, routines, or services), logic, profiles, and/or models used in embodiments described herein. In an embodiment, storage 225 comprises a data store (or computer data memory). Further, although depicted as a single data store component, storage 225 may be embodied as one or more data stores or may be in the cloud.

As shown in example system 200, storage 225 stores one or more user profiles 240; an example embodiment of which is illustratively provided in FIG. 2. Example user profile 240 includes information associated with a particular user including, among other things, information about identified user interactions, user account(s) and user device(s) data 244, user preferences 246, and content items 248. The information stored in user profiles 240 may be available to the routines or other components of example system 200.

As described previously, data stored in user interactions information component 242 may be determined from user activity monitor 280. User account(s) and user device(s) component 244 includes information about user devices accessed, used, or otherwise associated with a particular user, which may be determined from contextual information extractor 284, as described previously, or from user data. User account(s) and user device(s) component 244 also may include data associated with the user's user accounts, such as computer-related user accounts, online accounts (e.g., email, social media, etc.) such as a Microsoft .NET passport, user data relating to such accounts as user emails, texts, instant messages, calls, and other communications; social network accounts and data, such as news feeds; online activity; and calendars, appointments, application data, or the like. Some embodiments of user account(s) and user device(s) component 244 may store information across one or more databases, knowledge graphs, or data structures.

User preferences 246 generally include user settings regarding user preferences associated with specific user interactions, content, or personalization. Some preferences or settings may be explicitly provided by a user or inferred from user data or device features, as described previously. Content items 248 include content determined from personalization engine 260, which may include content logic. In some instances, content items 248 may include pending content items for future presentation to the user.

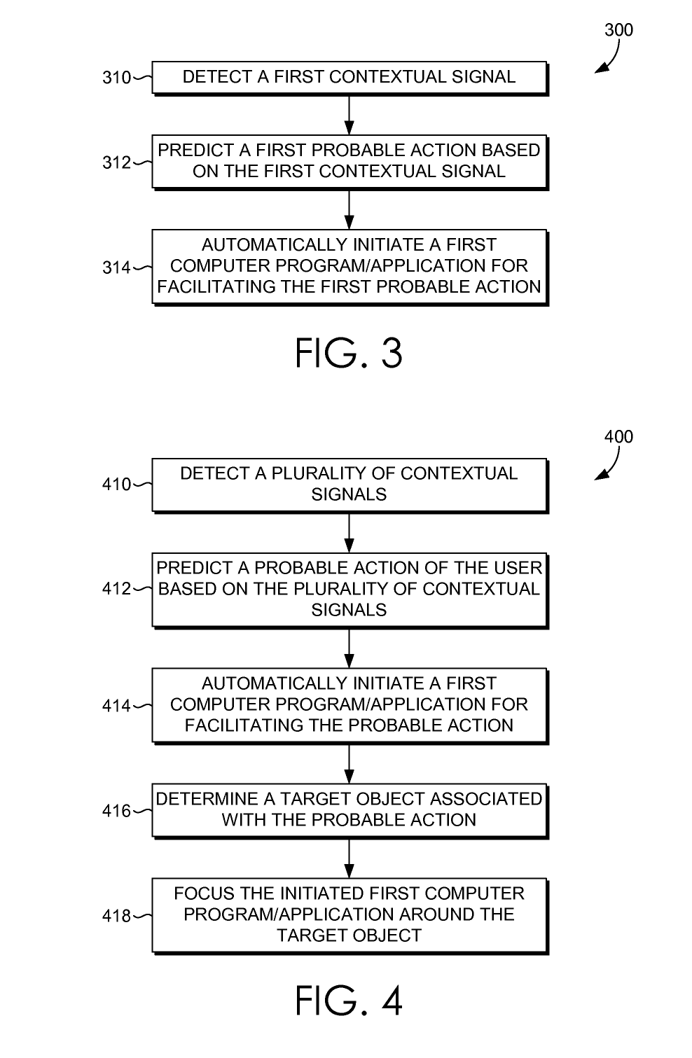

Turning now to FIG. 3, a flow diagram is illustrated showing an exemplary method 300 for tailoring a user computing experience based upon contextual signals, in accordance with aspects of the technology described herein. As indicated at block 310, at least one first contextual signal associated with a user of a computing device may be detected, for instance, utilizing user-data collection component 214 of the system 200 of FIG. 2. As indicated at block 312, a first probable action of the user based on the at least one first contextual signal may be predicted (e.g., utilizing the probable action inference engine 270 of the system 200 of FIG. 2). Such prediction may be made, by way of example only, taking into account historical actions of the user and/or cumulative historical actions of a plurality of users as such actions relate to the at least one first contextual signal detected. At least a first computer program or computer application selected from a plurality of computer programs and computer applications installed on the computing device may be automatically initiated (that is, without affirmative user interaction), as indicated at block 314. This may be accomplished, for instance, utilizing the action initiating component 274 of the probable action inference engine 270 of FIG. 2. In aspects, the first computer program or computer application may be configured for facilitating the first probable action.

With reference to FIG. 4, a flow diagram is illustrated showing another exemplary method 400 for customizing or tailoring a user experience based upon contextual signals, in accordance with aspects of the technology described herein. As indicated at block 410, a plurality of contextual signals associated with a user of a computing device may be detected, for instance, utilizing user-data collection component 214 of the system 200 of FIG. 2. As indicated at block 412, a probable action of the user based on the plurality of contextual signals may be predicted (e.g., utilizing the probable action inference engine 270 of the system 200 of FIG. 2). Such prediction may be made, by way of example only, taking into account historical actions of the user and/or cumulative historical actions of a plurality of users as such actions relate to the plurality of contextual signals detected. A computer program or computer application selected from a plurality of computer programs and computer applications installed on the computing device may be automatically initiated (that is, without affirmative user interaction), as indicated at block 414. This may be accomplished, for instance, utilizing the action initiating component 274 of the probable action inference engine 270 of FIG. 2. In aspects, the computer program or computer application may be configured for facilitating the probable action.

As indicated at block 416, a target object associated with the probable action may be determined, for instance, utilizing the object determining component 276 of the probable action inference engine 270 of FIG. 2. As indicated at block 418, the initiated computer program or computer application may be focused around the target object, e.g., utilizing the focusing component 278 of the probable action inference engine 270 of FIG. 2.

As can be understood, aspects of the technology described herein provide systems, methods, and computer-readable storage media for, among other things, tailoring or customizing user computing experiences based upon contextual signals and/or previous user actions and/or the previous actions of others. Contextual signals associated with a user of a computing device are detected. Based upon the detected contextual signals, a probable action of the user is predicted, for instance, taking into account historical actions of the user and/or cumulative historical actions of a plurality of users as such actions relate to the detected contextual signals. At least one computer program or computer application is automatically initiated (i.e., without affirmative user action), the initiated program or application being configured for aiding the user in engaging in the first probable action.

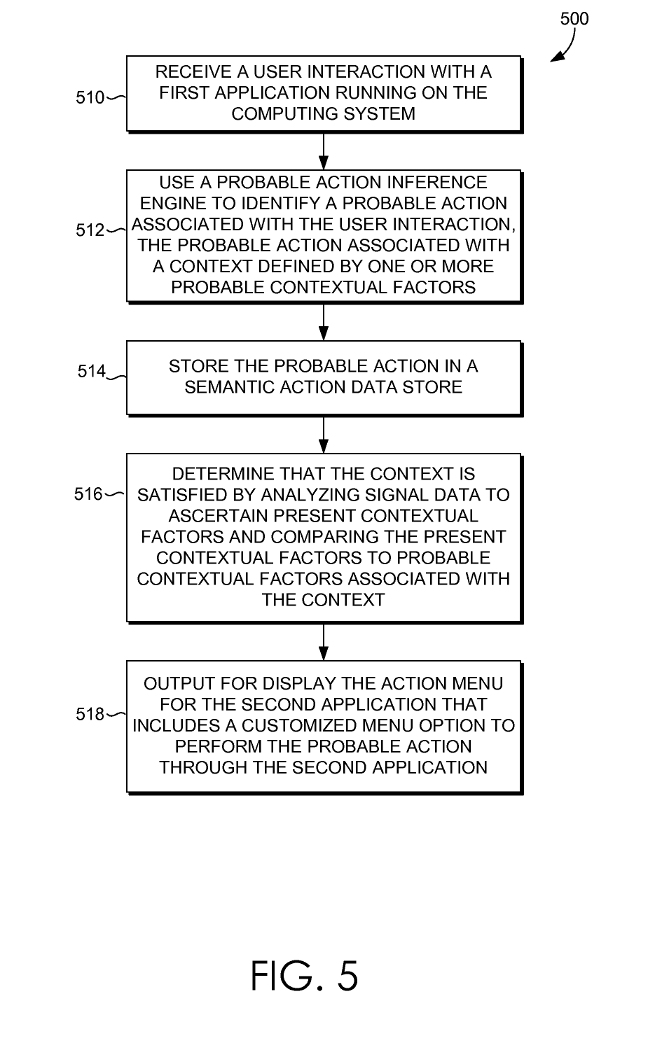

Turning now to FIG. 5, a method 500 of inferring a probable user action is described.

At step 510, a user interaction with a first application running on the computing system is received. The user interaction includes content.

At step 512, a probable action inference engine is used to identify a probable action associated with the user interaction. The probable action associated with a context defined by one or more probable contextual factors.

At step 514, the probable action is stored in a semantic action data store. The semantic action data store may be accessible across multiple devices associated with the first user. The probable action inference engine can access probable action sequences within the semantic action data store to determine when user actions conform with a designated sequence. Upon finding a confirmation, a user interface, such as a menu, may be modified to help the user perform the probable action.

At step 516, the context is determined to be satisfied by analyzing signal data to ascertain present contextual factors and comparing the present contextual factors to probable contextual factors associated with the context. In one aspect, the probable action is associated with a context that when satisfied by the present context can cause the customized interface to be presented or generated. For example, an initial action could be a user downloading photos. This can trigger activation of the probable action of sharing these photos. The context is opening a communication application, such as an email or texting application. Upon opening the texting application, a customized menu within the application can be generated to help the user share the specific photos to specific people designated in the photos, as one example.

At step 518, the action menu for the second application that includes a customized menu option to perform the probable action through the second application is output for display. The user may then select the customized menu option. Upon selecting the customized menu option, additional semantic data may be communicated to the application to help the application perform the action. For example, a photograph may show one or more people. The semantic information may include the email addresses of these people. The email addresses may be looked up in the user's contact information, social graph, or other data repository such as user profile 240. The semantic information is not necessarily found in the photograph or other user interaction with the photograph. In other cases, the semantic information is not taken from the user interaction. It should be noted that the user interaction can be with a first application running on a first device and the second application could be running on a second device. For example, a user could download photographs to a photo album from their mobile device using their mobile device. The user could then choose to share the photos using their personal computer or tablet.

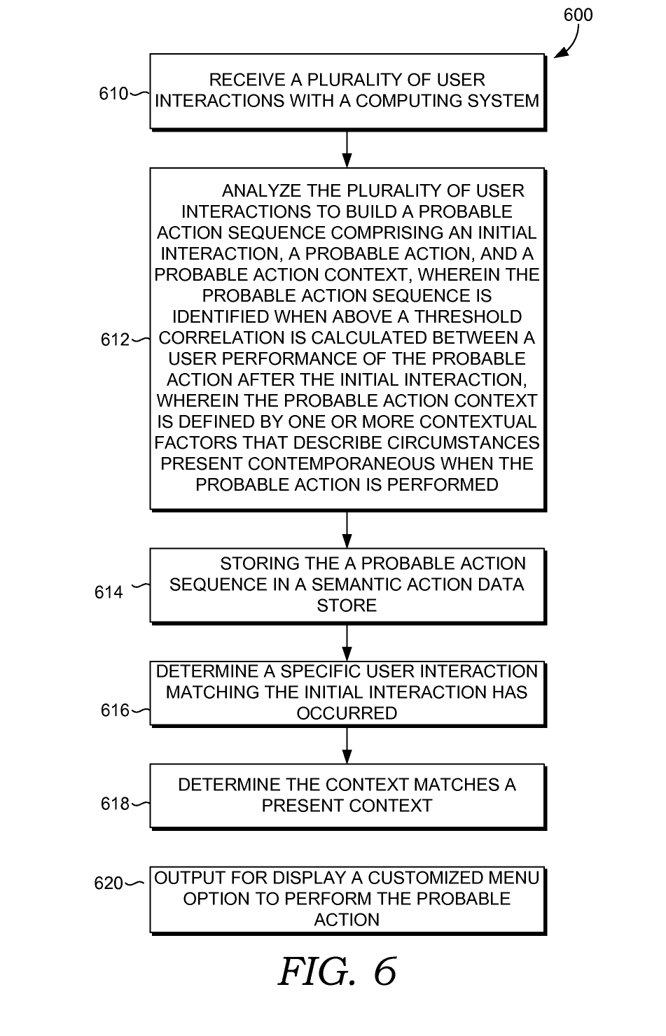

Turning now to FIG. 6, a method 600 of inferring a probable user action is provided. At step 610, a plurality of user interactions with a computing system are received.

At step 612, the plurality of user interactions are analyzed to build a probable action sequence. In some aspects, the plurality of user interactions may yield a plurality of probable action sequences. The probable action sequence comprises an initial interaction, a probable action, and a probable action context. The probable action sequence is identified when above a threshold correlation is calculated between a user performance of the probable action after the initial interaction. In other words, the user performs both the initial interaction in the probable action in sequence above a threshold number of times to establish a particular confidence score that the two actions are correlated. Further, the probable action may be associated with a context. The probable action context is defined by one or more contextual factors that describe circumstances present contemporaneous when the probable action is performed.

In some embodiments, probable action sequences can be generated using user interactions (which may include historical activity) from other similar users (i.e., crowdsourcing). In particular, user activity history may also be utilized in conjunction with a user's own activity history. For example, for a given user, a set of other users similar to the given user may be identified, based on having features or characteristics in common with the given user. This might include other users located in proximity to the given user, the given user's social media friends, work colleagues (which may be determined from an analysis of contextual information associated with the given user), other users with similar user interactions, or the like. Information about user activity history from the other users may be relied upon for inferring probable actions for the given user. This may be particularly useful in situations where little user activity history exists for the given user, such as where the user is a new user.

At step 614, the probable action sequence is stored in a semantic action data store. At step 616, a specific user interaction is determined to match the initial interaction. At step 618, the context is determined to match a present context.

At step 620, a customized menu option to perform the probable action is output for display upon determining the context matches the present context and the specific user action matches the initial interaction.

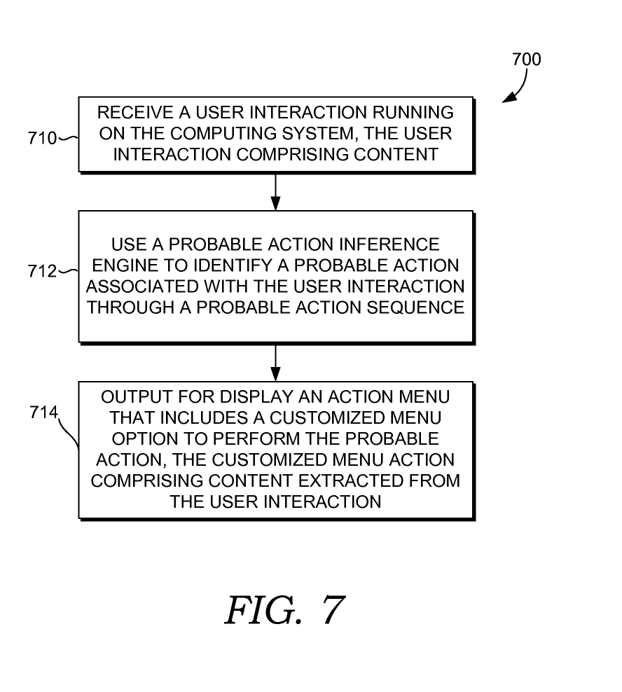

Turning now to FIG. 7, a method 700 of inferring a probable user action is provided. At step 710, a user interaction with the computing system is received. The user interaction comprising content. At step 712, a probable action inference engine is used to identify a probable action associated with the user interaction through a probable action sequence. At step 714, an action menu that includes a customized menu option to perform the probable action is output for display. The customized menu action comprising content extracted from the user interaction.

### Exemplary Operating Environment

Referring to the drawings in general, and initially to FIG. 8 in particular, an exemplary operating environment for implementing aspects of the technology described herein is shown and designated generally as computing device 800. Computing device 800 is but one example of a suitable computing environment and is not intended to suggest any limitation as to the scope of use of the technology described herein. Neither should the computing device 800 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 8, computing device 800 includes a bus 810 that directly or indirectly couples the following devices: memory 812, one or more processors 814, one or more presentation components 816, input/output (I/O) ports 818, I/O components 820, and an illustrative power supply 822. Bus 810 represents what may be one or more busses (such as an address bus, data bus, or a combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 8 is merely illustrative of an exemplary computing device that can be used in connection with one or more aspects of the technology described herein. Distinction is not made between such categories as “workstation,” “server,” “laptop,” “handheld device,” etc., as all are contemplated within the scope of FIG. 8 and refer to “computer” or “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 812 includes computer storage media in the form of volatile and/or nonvolatile memory. The memory 812 may be removable, non-removable, or a combination thereof. Exemplary memory includes solid-state memory, hard drives, optical-disc drives, etc. Computing device 800 includes one or more processors 814 that read data from various entities such as bus 810, memory 812, or I/O components 820. Presentation component(s) 816 present data indications to a user or other device. Exemplary presentation components 816 include a display device, speaker, printing component, vibrating component, etc. I/O ports 818 allow computing device 800 to be logically coupled to other devices, including I/O components 820, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 814 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 800. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 800. The computing device 800 may be equipped with depth cameras, such as stereoscopic camera systems, infrared camera systems, RGB camera systems, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

A computing device may include a radio 824. The radio 824 transmits and receives radio communications. The computing device may be a wireless terminal adapted to receive communications and media over various wireless networks. Computing device 800 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

What is claimed is:

1. A computing system comprising:
a processor;
one or more sensors configured to provide sensor data, including, at least location data for the mobile computing device; and
computer storage memory having computer-executable instructions stored thereon which, when executed by the processor, implement a method of inferring a probable user action, the method comprising:
(1) receiving, from a user, a user interaction with a first application running on the computing system, the user interaction comprising content;
(2) using a probable action inference engine to identify a probable action associated with the user interaction, the probable action associated with a context defined by one or more probable contextual factors;
(3) storing the probable action in a semantic action data store;
(4) determining that the context is satisfied by analyzing signal data to ascertain present contextual factors and comparing the present contextual factors to probable contextual factors associated with the context; and
(5) outputting for display the action menu for a second application that includes a customized menu option to perform the probable action through the second application.

2. The system of claim 1, wherein the semantic action data store is accessible across multiple devices associated with the user.

3. The system of claim 1, wherein the user interaction is one or more of an email sent by the user, an email received by the user, a text sent by the user, a text received by the user, and a social post associated with the user.

4. The system of claim 1, wherein the first application is running on a first computing device and the second application is running on a second computing device.

5. The system of claim 1, wherein a default version of the action menu does not include the customized menu option.

6. The system of claim 1, wherein the customized menu option includes text extracted from the content.

7. The system of claim 1, wherein the method further comprises, upon selection of the customized menu option, automatically communicating an additional content from the semantic action data store to the second application, wherein the additional content is used to complete the probable action and is not found in the content associated with the interaction.

8. A method of inferring a probable user action, the method comprising:
receiving a plurality of user interactions with a computing system;
analyzing the plurality of user interactions to build a probable action sequence comprising an initial interaction, a probable action, and a probable action context, wherein the probable action sequence is identified when above a threshold correlation is calculated between a user performance of the probable action after the initial interaction, wherein the probable action context is defined by one or more contextual factors that describe circumstances present contemporaneous when the probable action is performed;
storing the probable action sequence in a semantic action data store;
determining a specific user interaction matching the initial interaction has occurred;
determining the context matches a present context; and
outputting for display a customized menu option to perform the probable action.

9. The method of claim 8, wherein determining the context matches the present context comprises analyzing signal data to ascertain present contextual factors and comparing the present contextual factors to probable contextual factors associated with the context.

10. The method of claim 9, wherein the customized menu option comprises content extracted from the specific user interaction.

11. The method of claim 9, wherein the computing system comprises multiple end user devices associated with a user and the plurality of user interactions are with more than one of the multiple end user devices.

12. The method of claim 11, wherein the initial user interaction is performed on a first end user device and the customized menu option is output for display on a second end user device.

13. The method of claim 8, wherein the probable action sequence comprises an association rule between the initial interaction and the probable action.

14. The method of claim 8, wherein the method further comprises communicating the probable action sequence to a client device associated with the user.

15. The method of claim 8, wherein the initial user interaction is through a first application and the probable action is through a second application that is different from the first application.

16. One or more computer-storage media comprising computer-implemented instructions that when executed by a computer processor cause a computer to perform a method of inferring a probable user action comprising:
receiving a user interaction with the computing system, the user interaction comprising content;
using a probable action inference engine to identify a probable action associated with the user interaction through a probable action sequence;
outputting for display an action menu that includes a customized menu option to perform the probable action, the customized menu action comprising the content extracted from the user interaction.

17. The media of claim 16, further comprising:
receiving a plurality of user interactions with a computing system; and
analyzing the plurality of user interactions to build the probable action sequence comprising the user interaction, the probable action, and a probable action context, wherein the probable action sequence is identified when above a threshold correlation is calculated between a user performance of the probable action after the initial interaction.

18. The media of claim 17, wherein the probable action context is defined by one or more contextual factors that describe circumstances present contemporaneous when the probable action is performed, and wherein the method further comprises:
determining a specific user interaction matching the initial interaction has occurred; and
determining the context matches a present context;
wherein the customized action menu is output upon said determining the context matches the present context.

19. The media of claim 16, wherein the user interaction is taking a picture of a person and the probable action is communicating the picture to the person via email.

20. The media of claim 16, wherein the user interaction is a communication mentioning a musical artist and the probable action is accessing a song by the artist upon accessing a music playing application.
